(19) United States
(12) Patent Application Publication
(10) Pub. No.: US 2005/0231318 A1
(43) Pub. Date: Oct. 20, 2005

(54) Trip-free limit switch and reset mechanism

(76) Inventor: James Bullington, Athens, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/105,889

(22) Filed: Apr. 14, 2005

Related U.S. Application Data
(60) Provisional application No. 60/562,414, filed on Apr. 15, 2004.

(51) Int. Cl. H01H 73/00; H01H 71/16

(52) U.S. Cl. 337/36

(57) ABSTRACT

A high temperature limit switch is disclosed. The switch includes a resettable temperature responsive mechanism movable between a non-tripped position and a tripped position, a reset member movable between a position of rest and a reset position, a non-movable fixed contact, and a pivotable contact support member including a contact movable with respect to the non-movable fixed contact. The contact support member is configured to prevent the movable contact from engaging the fixed contact while the resettable temperature responsive mechanism is urged from the tripped position to the non-tripped position in response to force applied to the reset member until the reset member is returned toward the position of rest. A method of resetting a high temperature limit switch is also disclosed.

### CROSS REFERENCE TO RELATED APPLICATIONS

This application is related to U.S. Provisional Application No. 60/440,659 entitled “Trip-Free Limit Switch and Reset Mechanism” and filed on Jan. 16, 2003, which is incorporated herein by reference. This application claims priority to U.S. Provisional Application No. 60/562,414 entitled “Trip-Free Limit Switch and Reset Mechanism” and filed on Apr. 15, 2004, which is incorporated herein by reference.

### BACKGROUND OF THE INVENTION

1 Field of the Invention

The present invention relates generally to the field of electrical switches, and, more particularly, to a resettable thermostatic switch capable of automatically moving to an open condition responsive to an elevated temperature.

While the invention is subject to a wide range of applications, it is particularly well suited for use as a safety device to disconnect power to an electric water heater when the maximum temperature set-point has been exceeded.

2. Related Art

Devices such as hot water heaters, furnaces, and other appliances commonly include a thermostat, which incorporates a temperature limit switch for deactivating the device responsive to an undesirably elevated temperature condition. Such thermostats often include a bimetallic disc, a portion of which is designed to change position when a predetermined threshold temperature is reached, thereby providing an indication of some type. Such bimetallic discs generally include a high expansion material having a relatively large coefficient of thermal expansion on one side and a low expansion material having a relatively low coefficient of thermal expansion on an opposite side. As is known in the art, as the temperature increases, the high expansion side expands more rapidly than the low expansion side and eventually causes the disc to snap from one position to a second position (i.e., from a concave shape to a convex shape). It is therefore possible to have the disc snap back and forth between two known temperatures, which are determined by the materials used and other factors, as are well known in the art.

The back and forth snapping action takes place with some hysteresis involved. This means that if the disc will snap from a first to a second position at a predetermined high temperature, it will not snap back to its first position until a predetermined low temperature is reached. Accordingly, if the ambient temperature is between the predetermined high and low temperatures, the disc will operate bi-stably and not return to its first position unless the ambient temperature is dropped to below the predetermined low temperature where the disc may then be physically forced back to the first position. More specifically, if the disc is initially in a first position, it will be caused to snap by, for example, reaching of the predetermined high temperature. The disc may then be reset by physically pushing the disc back to the original first position. Generally, thermostats of the above-described type, when operated in the bi-stable condition, are returned to the original first or reset position by means of a manual reset device.

Generally speaking, the purpose of the thermostat is to operate in response to a high temperature alarm condition (the predetermined high temperature) to open a switch and maintain the switch open until it is manually reset after the alarm condition has abated. Many known thermostats, however, have no provision for preventing override thereof by manually operating the reset device, preventing the disc from snapping, or physically maintaining the switch closed by continual operation of the reset mechanism, regardless of whether the alarm condition has abated or not. As a result, thermostats on hot water heaters, furnaces, and other appliances are often manually overridden and the devices controlled by such thermostats are allowed to operate during an alarm condition (at temperature exceeding the safe temperature threshold). Because of, among other things, numerous accidents resulting from such unsafe operation, regulations have now been implemented to require that thermostats be fitted with “trip-free” high temperature limit control switches.

The Underwriters Laboratories, Inc. regulations applicable to the design and operation of a high temperature limit control switch are as follows:

11. Reset Mechanism—Limiting Control

11.1 A control shall not reset or be resettable manually or otherwise so that operation of the controlled appliance can be resumed until after a safe operating condition is restored. For example, pressure or temperature returned to a value at or below a control set point.

11.3 A manually reset device shall be trip-free; that is, the automatic tripping shall be independent of the manipulation or position of the reset button, handle, lever, or the like.

Since the implementation of the above-mentioned regulations, numerous approaches have been employed to manufacture thermostats, and specifically high temperature limit switches, that comply with UL regulations. Many of these approaches are difficult to manufacture, require a number of moving components, and require complex assembly procedures. In addition, many such devices incorporate one or more coil springs, which have a tendency to fail over time.

What is needed therefore, but seemingly unavailable in the art, is a manually resettable high temperature limit switch for thermostats that overcomes these and other shortcomings known in the art. Such a resettable high temperature limit switch should be easy to manufacture, occupy a limited amount of space, incorporate relatively few moving components, and be less expensive than other resettable high temperature limit switches presently available in the art. It is to the provision of such a manually resettable high temperature limit switch that the present invention is primarily directed.

### SUMMARY

In one aspect, the present invention is directed to a switch. The switch includes a resettable temperature responsive mechanism movable between a non-tripped position and a tripped position, a reset member movable between a position of rest and a reset position, a non-movable fixed contact, and a pivotable contact support member including a contact movable with respect to the non-movable fixed contact.

The contact support member is configured to prevent the movable contact from engaging the fixed contact while the resettable temperature responsive mechanism is urged from the tripped position to the non-tripped position in response to force applied to the reset member until the reset member is returned toward the position of rest.

In another aspect, the present invention is related to a high temperature limit switch. The high temperature limit switch includes a resettable temperature responsive mechanism movable between a non-tripped position and a tripped position, a movable actuator constructed and arranged to cooperate with the resettable temperature responsive mechanism, a reset member movable between a position of rest and a reset position, a fixed pivot point, a non-movable fixed contact and a pivotable contact support member having a contact movable with respect to the non-moveable fixed contact. The contact support member is configured to cooperate with the fixed pivot point to prevent the movable contact from engaging the non-movable fixed contact while the resettable temperature responsive mechanism is urged from the tripped position to the non-tripped position in response to force applied to the reset member.

In yet another aspect, the present invention is directed to a method of resetting a high temperature limit switch. The method includes the steps of moving a reset member from a position of rest toward a reset position to exert force on a contact support member having a contact movable with respect to a non-movable fixed contact, and depressing an actuator in response to the moving step to move a resettable temperature responsive mechanism from a tripped position to a non-tripped position without allowing the movable contact to engage the non-movable fixed contact until the reset member is returned toward the position of rest.

A further aspect of the present invention is directed to a method of resetting a high temperature limit switch. The method includes the steps of moving a reset member from a position of rest toward a reset position to exert force on a contact support member having a fixed end and a first contact remote from the fixed end, and pivoting the contact support member at a fixed pivot point disposed between the fixed end and the first contact in response to the moving step to prevent the first contact from engaging a second contact while a resettable temperature responsive mechanism is urged from a tripped position to a non-tripped position.

A still further aspect of the present invention relates to a high temperature limit switch. The high temperature limit switch includes a resettable temperature responsive mechanism movable between a non-tripped position and a tripped position, a reset member movable between a position of rest and a reset position, a pivotable contact support member including a fixed end and a first contact remote from the fixed end, a fixed contact configured to receive the first contact, a pivot point disposed between the first end and the first contact, and a movable actuator disposed between the pivot point and the first contact to urge the resettable temperature responsive mechanism from the tripped position to the non-tripped position in response to movement of the reset member in the direction of the reset position. The first contact is prevented from contacting the fixed contact by force applied at the pivot point until the reset member is returned toward the position of rest.

The switch and method of resetting a high temperature limit switch of the present invention provides a number of advantages over other temperature limit switches and methods known in the art. For example, the resettable high temperature limit switch of the present invention incorporates relatively few movable parts and does not include a coil spring. As a result, the switch of the present invention is not susceptible to failure, is robust, and is consistent in operation.

In addition, the limit switch of the present invention does not permit closing of the electrical circuit (i.e., engagement of the electrical contacts) until after the reset member is returned toward its position of rest (e.g., when the reset member is released following resetting of the resettable temperature responsive mechanism to the non-tripped position). As a result, the high temperature limit switch of the present invention is a “fail-safe” mechanism. More specifically, if the resettable temperature responsive mechanism does not remain in its non-tripped position when the rest member is released or otherwise moves toward its position of rest following an attempt to reset the switch, engagement of the contact members, and thus completion of the electrical circuit, cannot occur.

Additional features and advantages of the invention will be set forth in the detailed description which follows and in part will be readily apparent to those skilled in the art from that description or recognized by practicing the invention as described herein.

It is to be understood that both the foregoing general description and the following detailed description are merely exemplary of the invention, and are intended to provide an overview or framework for understanding the nature and character of the invention as it is claimed. The accompanying drawings are included to provide further understanding of the invention, illustrate various embodiments of the invention, and together with the description serve to explain the principles and operation of the invention.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 is a block diagram illustrating a switch in accordance with one exemplary embodiment of the present disclosure for controlling operation of a water heater.

FIG. 2 schematically depicts an exemplary embodiment of the switch of FIG. 1 in a non-tripped or closed position.

FIG. 3 schematically depicts the exemplary switch of FIG. 2 in a tripped or open position.

FIG. 4 schematically depicts the exemplary switch depicted in FIGS. 2 and 3 being reset to a non-tripped or closed condition.

FIG. 5 is a flowchart illustrating an exemplary methodology of using the switch depicted by FIGS. 2-4.

FIG. 6 is an exploded perspective view of a thermostat incorporating a preferred high temperature limit switch in accordance with the present invention.

FIG. 7 is a partial perspective view of the preferred high temperature limit switch depicted in FIG. 4 showing the placement of the movable actuator with respect to the fulcrum in accordance with the present invention.

FIG. 8 is a partial perspective view of the high temperature limit switch depicted in FIG. 7 showing the placement of pivotable contact support members in accordance with the present invention.

FIG. 9 is a top plan view of the thermostat depicted in FIG. 6 showing the preferred high temperature limit switch assembled in accordance with the present invention.

FIG. 10 is a cross-sectional view of the thermostat of FIG. 9 depicting the preferred high temperature limit switch mounted within the switch housing in a non-tripped or closed position.

FIG. 11A is a cross-sectional view of the thermostat of FIG. 9 depicting the preferred high temperature limit switch mounted within the switch housing and shown in a thermally tripped or open position.

FIG. 11 B is an exploded perspective view of the preferred high temperature limit switch depicted in FIG. 11A.

FIG. 12 is a cross-sectional view of the thermostat of FIG. 9 depicting the preferred high temperature limit switch mounted within the switch housing and showing the resettable temperature responsive mechanism being reset by force applied to the reset member.

FIG. 13 is a top plan view of a preferred pivotable contact support member in accordance with the present invention.

FIG. 14A depicts an alternate view of the thermostat depicted in FIG. 9.

FIG. 14B is a cross-sectional view of the thermostat of FIG. 14A.

FIG. 14C is an exploded perspective view of the thermostat of FIG. 14B.

FIG. 15 is an exploded perspective view of the thermostat of FIG. 6.

### DETAILED DESCRIPTION

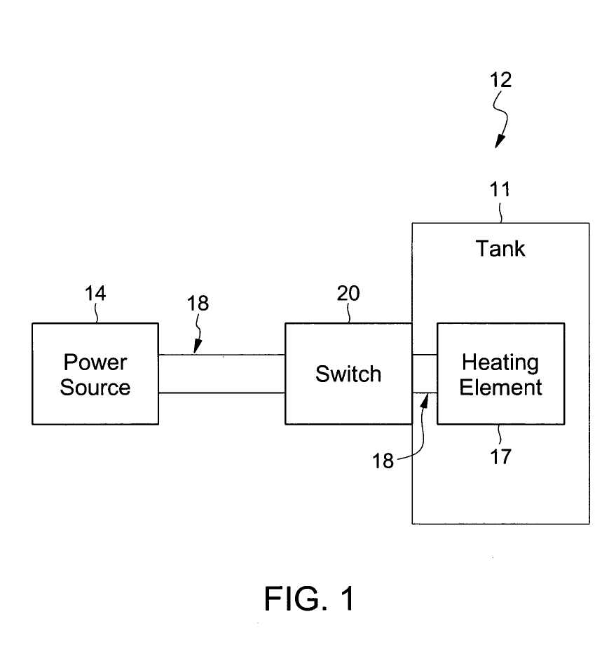

Reference will now be made in detail to the present preferred embodiments of the invention, examples of which are illustrated in the accompanying drawing figures. An exemplary embodiment of a switch of the present invention is shown in FIG. 1 and is designated generally throughout by reference numeral 20.

In FIG. 1, the switch 20 is mounted on a tank 11 of a water heater 12. The switch 20 is coupled to a power source 14, which delivers power to at least one heating element 17 within the tank 11. In this regard, the switch 20 is coupled to the power source 14 and the heating element 17 via conductive connections 18 that allow current to flow from the power source 14 through the switch 20 and the heating element 17. When activated by a controller (not shown), the heating element 17 converts current from the power source 14 into heat in order to heat water residing in the tank 11. If the temperature sensed by the switch 20 exceeds a threshold, the switch 20 trips in order to prevent current from flowing through the switch 20 thereby forcing the heating element 17 to deactivate and/or remain in a deactivation state until the switch 20 is later reset into a non-tripped state. Techniques for transitioning the switch 20 between a tripped state and a non-tripped state will be described in more detail below. Although the switch 20 is shown as being used to control the flow of current to a heating element 17 within a water heater 12, it should be emphasized that the switch 20 may be used to control the flow of current to various other devices, and the present invention is not limited to the water heater example described herein.

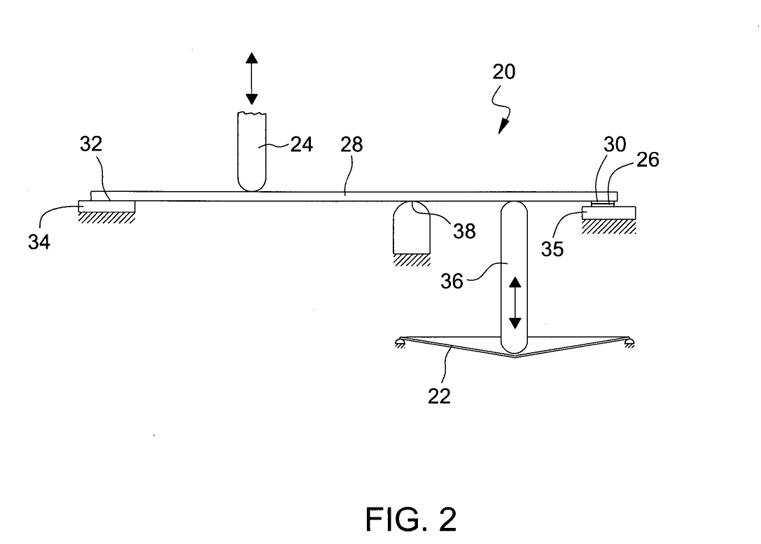

Generally speaking, and as depicted in FIGS. 2-4, switch 20 may preferably include a resettable temperature responsive mechanism 22, which is movable between a non-tripped position and a tripped position, a reset member 24 movable between a position of rest and a reset position, a non-movable fixed contact 26 and a pivotable contact support member 28, preferably including a movable contact 30 depicted adjacent fixed contact 26. FIG. 2 depicts switch 20 in its operational or normal position, i.e., with contacts 26 and 30 engaged or closed such that electrical current can flow through the switch 20 via the pivotable contact support member 28 and contacts 26 and 30.

Pivotable contact support member 28 is preferably mounted to include a fixed end 32 adjacent a stationary support 34 and is preferably a flexible member made of a conductive material such as copper, brass or some other metal. The opposite end of pivotable contact support member 28, which carries movable contact 30, is preferably a free end adapted for movement into and out of contact with non-movable fixed contact 26 mounted on stationary contact member 35. As will be described in greater detail below, movement of the free end of pivotable contact support member 28, and thus movement of movable contact 30, into and out of engagement with non-movable fixed contact 26 is facilitated by an actuator 36 adapted to cooperate with resettable temperature responsive mechanism 22 to urge the free end of pivotable contact support member 28 out of engagement with stationary contact member 35. As shown by FIG. 2, a fixed fulcrum 38 abuts the pivotable contact support member 28 and is disposed between the ends of pivotable contact support member 28. The fixed fulcrum 38 provides a pivot point for the pivotable contact support member 28 and functions to maintain the free end of pivotable contact support member 28 out of engagement with stationary contact member 35 while reset member 24 is moved toward its reset position as will be described in greater detail below.

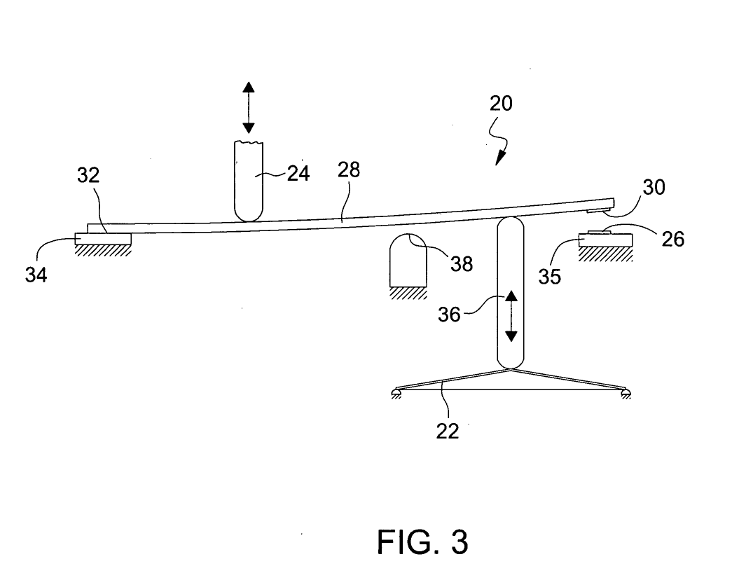

FIG. 3 depicts switch 20 in a tripped or open circuit condition. Once a thermal threshold or trip point is reached, resettable temperature responsive mechanism 22, preferably a bi-metallic disc, snaps from its non-tripped position depicted in FIG. 2 to a tripped position as depicted in FIG. 3. As resettable temperature responsive mechanism 22 trips, actuator 36 is moved in the direction of pivotable contact support member 28 and urges the free end of pivotable contact support member 28 out of engagement with stationary contact member 35, thus breaking the contact between non-movable fixed contact 26 and movable contact 30, which in turn, breaks the circuit. In the case of, for example, a hot water heater, the tripping action depicted in FIG. 3 is typically caused by an undesirably elevated temperature condition. Thus, when the circuit is broken, power to the device controlled by the thermostat is terminated until switch 20 may be reset. Again, in the case of a hot water heater, power to the heating elements is discontinued until the high temperature condition or alarm condition, is abated and switch 20 is reset.

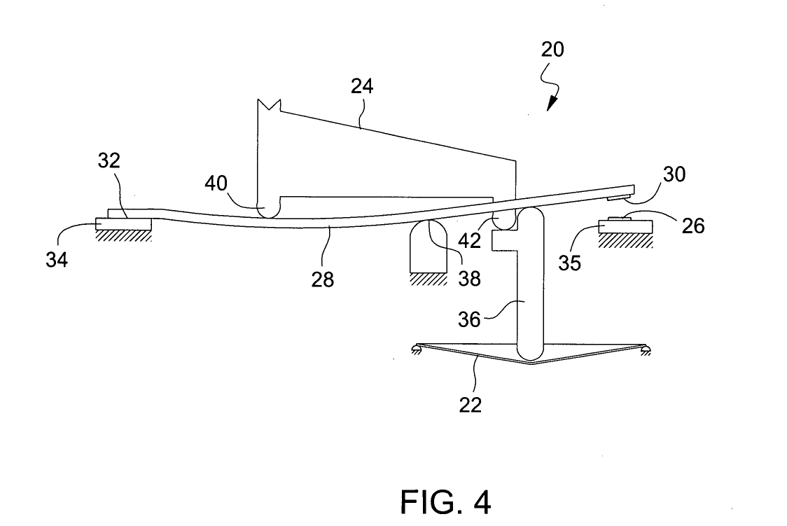

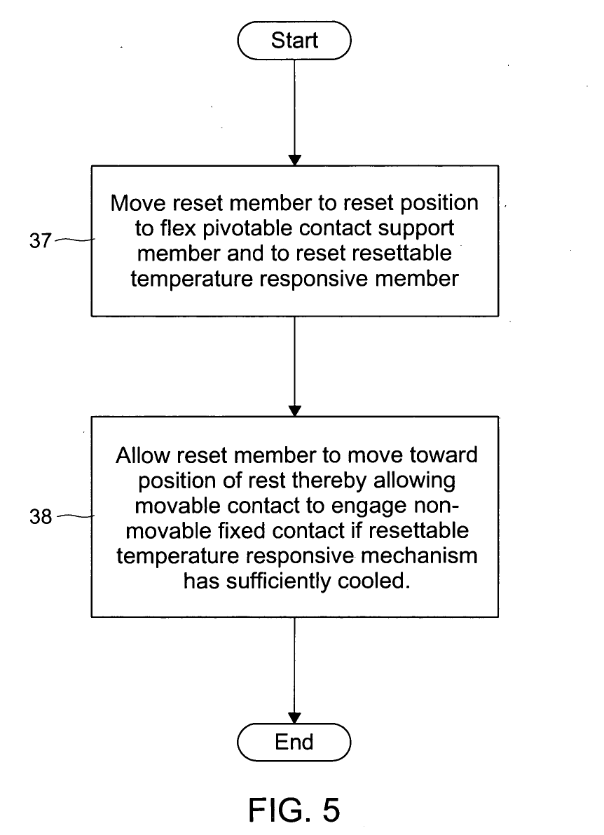

FIG. 4 depicts switch 20 being reset in accordance with the present invention. As shown in the drawing figure, reset member 24 is depressed such that it flexes pivotable contact support member 28 and moves actuator 36 to reset resettable temperature responsive mechanism 22, as shown by block 37 of FIG. 5. In a preferred embodiment, reset member 24 is constructed and arranged to contact pivotable contact support member 28 with a first projection 40 while contacting actuator 36 with a second projection 42. Thus, while reset member 24 is urged in the direction of pivotable contact support member 28, second projection 42 urges actuator 36 toward resettable temperature responsive mechanism 22 while first projection 40 urges a portion of pivotable contact support member 28 toward resettable temperature responsive mechanism 22 as well. During this procedure, however, another portion of pivotable contact support member 28 is pivoted about fulcrum 38 such that the free end of pivotable contact support member 28 is deflected away from stationary contact member 35. As a result, engagement of non-movable fixed contact 26 with movable contact 30 is prevented. If resettable temperature responsive mechanism 22 has sufficiently cooled, it will preferably snap from the tripped position depicted in FIG. 3 back to the non-tripped position depicted in FIG. 4, thus allowing switch 20 to be reset as force is withdrawn from reset member 24 and reset member 24 moves back toward its position of rest, as shown by block 38 of FIG. 5. More specifically, when resettable temperature responsive mechanism 22 is reset to its non-tripped position as depicted in FIG. 4, actuator 36 moves sufficiently away from pivotable contact support member 28 to allow free end of pivotable contact support member 28 to move into engagement with stationary contact member 35 as reset member 24 approaches its position of rest. As a result, movable contact 30 engages non-movable fixed contact 26 and the circuit is closed or completed by switch 20, thereby restoring power to the device controlled by the thermostat incorporating switch 20 of the present invention.

If, however, resettable temperature responsive mechanism 22 has not sufficiently cooled to enable resettable temperature responsive mechanism 22 to be reset to its non-tripped position, resettable temperature responsive mechanism 22 will snap back to the tripped position depicted in FIG. 3 as reset member 24 moves toward its position of rest causing actuator 36 to engage pivotable contact support member 28 before movable contact 30 may engage non-movable fixed contact 26. As a result, switch 20 may not be closed and the circuit may not be completed, thus providing the “trip-free” operation required by the UL regulations described above.

Although an exemplary switch 20 and method of operation has been described above with reference to FIGS. 2-4, those of skill in the art will recognize that switch 20 may be constructed, configured and operated in numerous ways consistent with the functionality of the present invention. One such preferred implementation will now be described below with reference to FIGS. 6-15.

While the switch of the present invention may have several applications, it will be described hereafter as a high temperature limit control switch for a domestic hot water heater, wherein water is heated in an enclosed tank by a suitable heat source such as an electric heating element. Such a water heater, water heater tank, thermostat, and electric heating element may be of conventional design and thus are not described in detail herein.

A thermostat 44 including a preferred switch 20 in accordance with the present invention is depicted in an exploded prospective view in FIG. 6. The electronics (not shown) of thermostat 44 are housed between a thermostat cover 46 and a bottom plate 48 while switch 20 shares the thermostat cover 46 and bottom plate 48. The housing assembly further includes a reset cover 50. In accordance with the preferred embodiment, resettable temperature responsive mechanism, preferably a bimetallic snap disc 52, communicates with the hot water heater tank (not shown) via snap disc seat 53 in bottom plate 48. Actuator 54 communicates with bimetallic snap disc 52 and is configured for vertical translation with respect to bimetallic snap disc 52 via actuator guide 56 as depicted in FIG. 6. Switch 20 further preferably includes a pair of pivotable contact support members 58. While only one pivotable contact support member 58 is required for high temperature limit control provided by conventional thermostats, two or more pivotable contact support members may be employed when additional electronic devices and/or functionality is to be controlled via the same switch 20. As depicted in FIG. 6, pivotable contact support members 58 include a first end 60 adapted to be fixed and a second end 62 adapted to be movable when pivotable contact support members 58 are seated adjacent actuator guide 56 in accordance with the present invention. In a preferred embodiment, each pivotable contact support member 58 includes a reset arm 64, the operation of which will be described in greater detail below.

Under normal operating conditions, i.e., when switch 20 is closed and the electrical circuit is complete, pivotable contact support member 58 is seated adjacent actuator guide 56 such that first end 60 is fastened to stationary support 66 while movable contact 68 adjacent second end 62 of pivotable contact support member 58 is in contact with stationary contact member 70. Reset button 72 is positioned atop of pivotable contact support members 58 and actuator 54 and is held in position by reset cover 50.

Reset button 72 is preferably constructed and arranged such that it may cooperate with both pivotable contact support members 58 and actuator 54. In a preferred embodiment, and when utilized to manually reset switch 20, central portion 74 of reset button 72 communicates with post 76 of actuator 54 while extended detents 78 communicate with reset arms 64 of pivotable contact support members 58. Although not required, reset button 72 may also include biasing tabs 80 to provide the resilient “feel” typically associated with manual reset buttons conventionally employed with thermostats. Although not readily perceptible in FIG. 6, switch 20 also includes a pair of fulcrums 82, the function of which will be described in greater detail below.

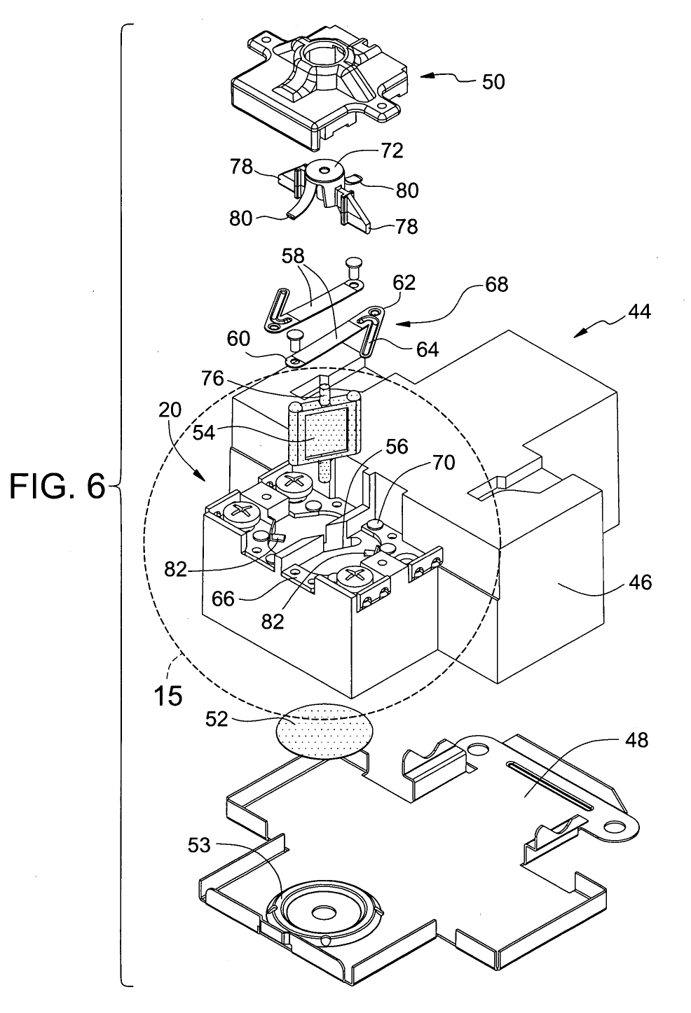

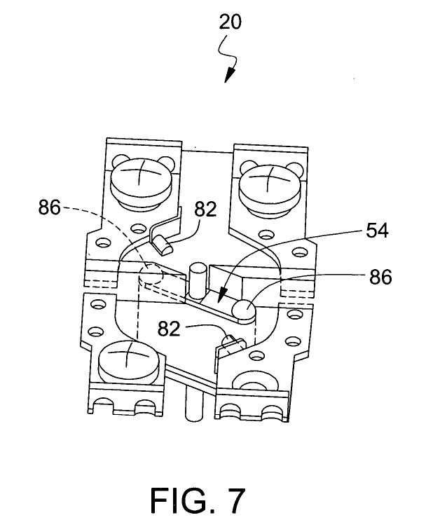

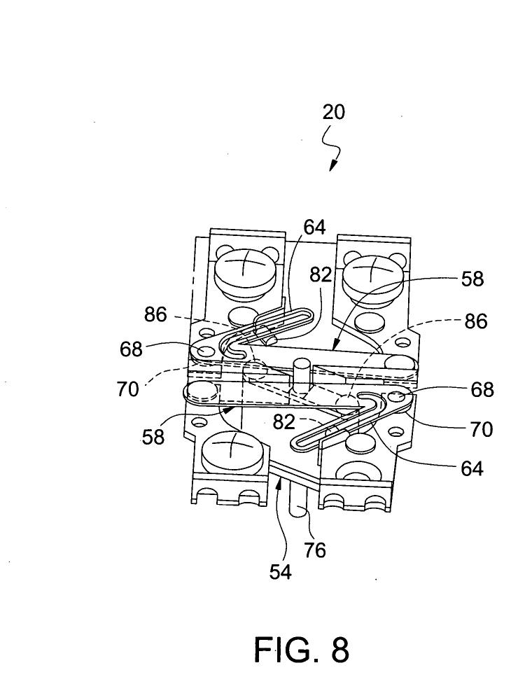

Fulcrums 82, at least one of which cooperates with each pivotable contact support member 58, together with actuator 54 are depicted more clearly in FIG. 7. In FIG. 8, pivotable contact support members 58 have been added to the drawing figure to more clearly illustrate the cooperation of reset arms 64 with fulcrums 82. Although not depicted in FIG. 8, extendable detents 78 of reset buttons 72 are preferably configured to engage reset arms 64 at engagement points 84 while central portion 74 of reset button 72 is configured to engage actuator 54 at post 76. Fulcrums 82 provide the pivot points about which second ends (free ends) 62 of pivotable contact support members 58 pivot when force is exerted atop of engagement points 84 by reset button 72. Thus, as will be described in greater detail below, unless actuator 54 is at a position of rest within switch 20 while reset member 72 is at its position of rest, or nearing the end of its movement toward its position of rest (depending upon the amount of play in the switch), movable contact 68 and stationary contact member 70 will be prevented from making contact.

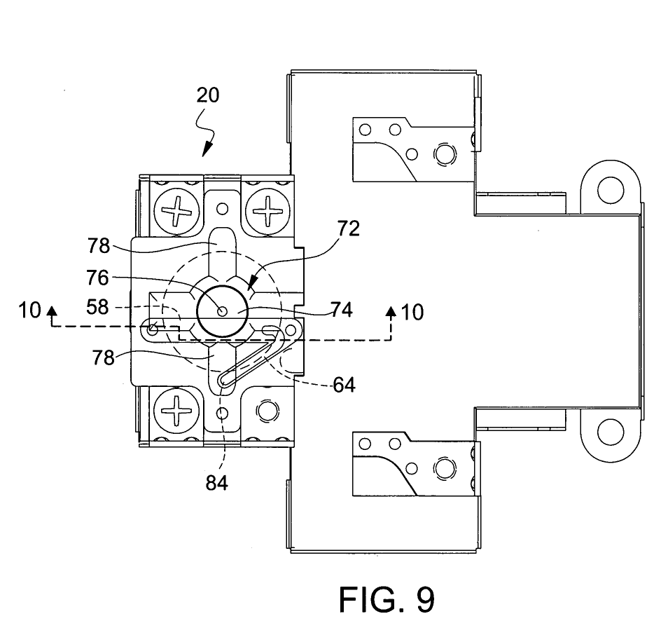

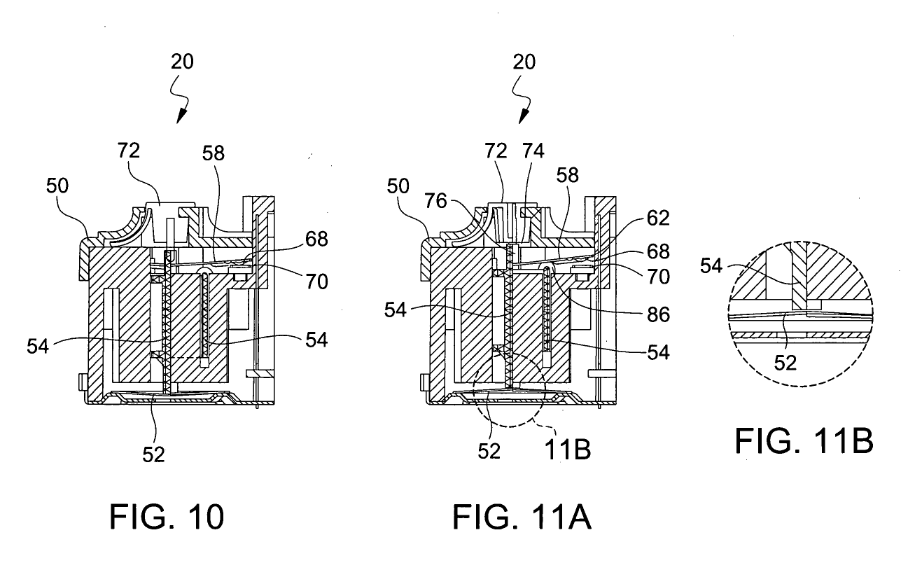

The operation of the preferred switch 20 of the present invention will now be described with reference to FIGS. 9-13. FIG. 9 depicts the cooperation of reset member 72 with the post 76 of actuator 54 and the reset arm 64 of pivotable contact support member 58. As indicated in the figure, central portion 74 of reset member 72 communicates with post 76 while extended detents 78 of reset member 72 communicate with engagement points 84 of reset arms 64. A cross-sectional view of switch 20 is depicted in FIG. 10. Switch 20 is shown in a closed or non-tripped position. Accordingly, the bi-metallic snap disc 52 is in a non-tripped position (concave in appearance), actuator 54 is at a position of rest and thus not exerting any force on contact member 58, movable contact 68 and stationary contact member 70 are engaged (thus completing the circuit), and reset button 72 is likewise at a position of rest.

As shown in FIGS. 11A and 11B, switch 20 has been thermally tripped such that bimetallic snap disc 52 is in a tripped state (convex in shape). Accordingly, actuator 54 has been moved toward reset member 72 such that tab 86 atop actuator 54 causes the second or free end 62 of pivotable contact support member 58 to move away from stationary contact member 70, thus breaking contact between movable contact 68 and stationary contact member 70. As shown clearly in FIG. 11A, central portion 74 of reset member 72 may now preferably engage post 76 of actuator 54 in order to facilitate manual resetting of switch 20.

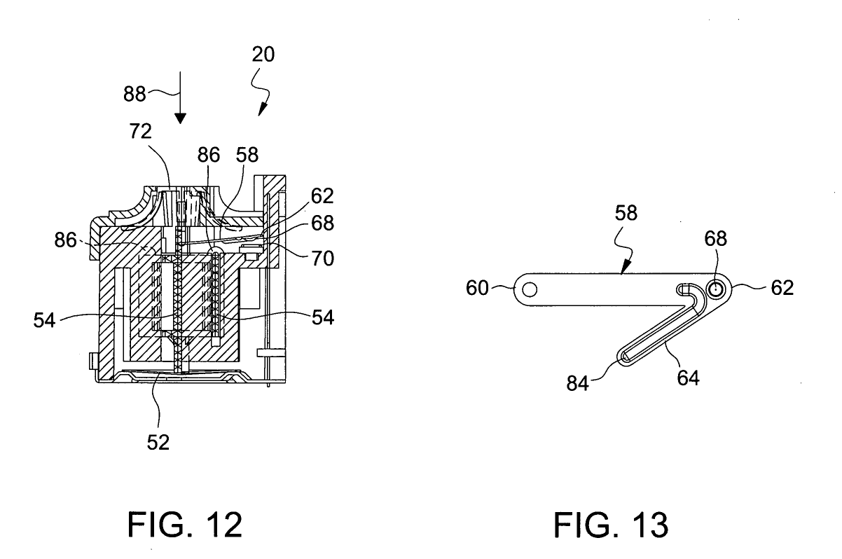

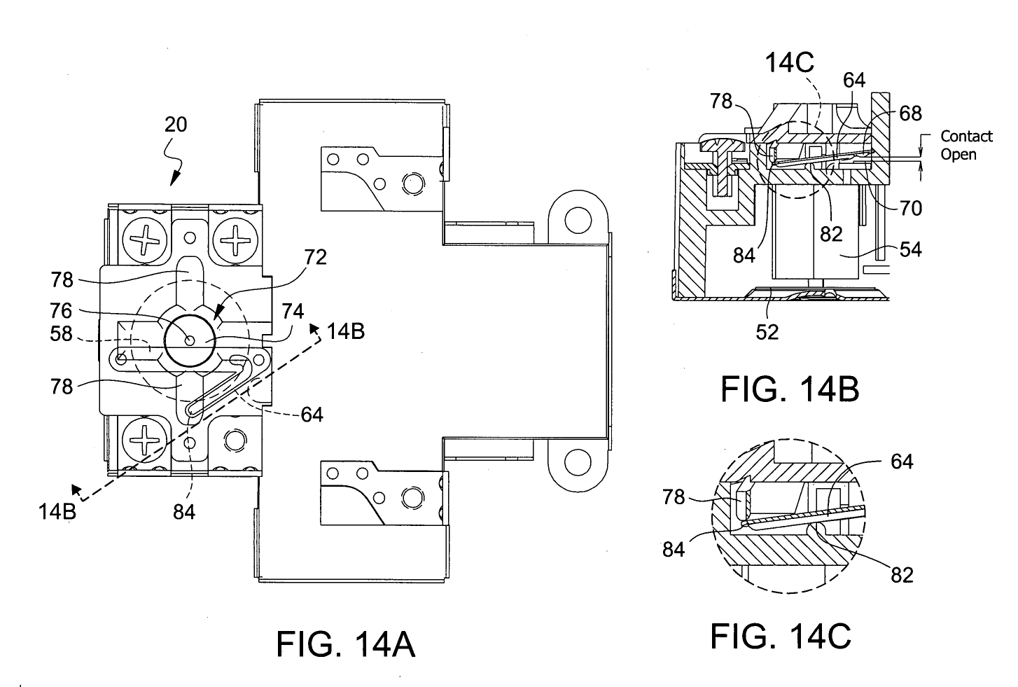

In accordance with manual reset procedures, and as depicted in FIG. 12, reset member 72 may be urged in the direction of directional arrow 88 in order to move actuator 54 from its tripped position to a reset position, which in turn moves bi-metallic snap disc 52 from a tripped position back to its non-tripped reset position. As shown in FIGS. 13, 14A, 14B, and 14C, extended detent 78 of reset member 72 exert force at engagement points 84 of reset arm 64 causing reset arm 64 and thus pivotable contact support member 58 to pivot about fulcrum 82. Referring again to FIG. 12, this action continues to force second or free end 62 away from stationary contact member 70 while switch 20 is being reset. Thus, as mentioned previously, if bi-metallic snap disc 52 is sufficiently cooled such that it snaps back to a non-tripped position and remains at a non-tripped position, movable contact 68 will not engage stationary contact member 70 until reset member 72 is moved back toward its position of rest while actuator 54 and bimetallic snap disc 52 remain in a non-tripped position.

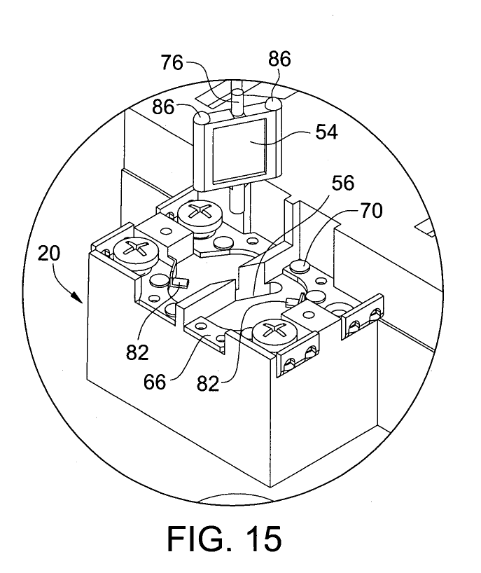

FIG. 15 has been provided to provide further detail of the view depicted in FIG. 6. It will be understood by those skilled in the art that FIGS. 6-15 depict only one preferred embodiment of the present invention and that switch 20 of the present invention may be configured in any number of different ways.

It will be apparent to those skilled in the art that various modifications and variations can be made to the present invention without departing from the spirit and scope of the invention.

While the present invention has been described in detail, it is to be expressly understood that it will be apparent to persons skilled in the relevant art that the invention may be modified without departing from the spirit of the invention. Various changes of form, design or arrangement may be made to the invention without departing from the spirit and scope of the invention. Therefore, the above mentioned description is to be considered exemplary, rather than limiting and the true scope of the invention is that defined in the following claims.

1. A switch comprising:
a resettable temperature responsive mechanism movable between a non-tripped position and a tripped position;
a reset member movable between a position of rest and a reset position;
a non-movable fixed contact; and
a pivotable contact support member including a contact movable with respect to the non-movable fixed contact, wherein the contact support member is configured to prevent the movable contact from engaging the fixed contact while the resettable temperature responsive mechanism is urged from the tripped position to the non-tripped position in response to force applied to the reset member until the reset member is returned toward the position of rest.

2. The switch of claim 1, further comprising a fulcrum abutting the contact support member.

3. The switch of claim 2, wherein the reset member is pressed against the contact support member as the reset member is being moved from the position of rest to the reset position causing the contact support member to pivot about the fulcrum.

4. The switch of claim 1, further comprising an actuator disposed between the contact support member and the temperature responsive member, wherein the temperature responsive mechanism causes the actuator to press against the contact support member as the temperature responsive mechanism moves from the non-tripped position to the tripped position.

5. The switch of claim 4, wherein the contact support member includes a fixed end and wherein the movable contact is remote from the fixed end.

6. The switch of claim 5, further comprising a fulcrum abutting the contact support member between the contact and the fixed end.

7. The switch of claim 4, further comprising a fulcrum abutting the contact support member on a first side of the contact support member, wherein the actuator presses against the first side of the contact support member.

8. The switch of claim 7, wherein the reset member presses against a second side of the contact support member, the second side opposite of said first side.

9. A high temperature limit switch comprising:
a resettable temperature responsive mechanism movable between a non-tripped position and a tripped position;
a moveable actuator constructed and arranged to cooperate with the resettable temperature responsive mechanism;
a reset member movable between a position of rest and a reset position;
a fixed pivot point;
a non-movable fixed contact; and
a pivotable contact support member having a contact movable with respect to the non-movable fixed contact, wherein the contact support member is configured to cooperate with the fixed pivot point to prevent the movable contact from engaging the non-movable fixed contact while the resettable temperature responsive mechanism is urged from the tripped position to the non-tripped position in response to force applied to the reset member.

10. The switch of claim 9, wherein the reset member is pressed against the contact support member as the reset member is being moved from the position of rest to the reset position thereby causing the contact support member to pivot about a pivot point.

11. The switch of claim 9, wherein the reset member is pressed against the contact support member as the reset member is being moved from the position of rest to the reset position thereby flexing the contact support member.

12. A method of resetting a high temperature limit switch, the method comprising the steps of:
moving a reset member from a position of rest toward a reset position to exert force on a contact support member having a contact movable with respect to a non-movable fixed contact; and
depressing an actuator in response to the moving step to move a resettable temperature responsive mechanism from a tripped position to a non-tripped position without allowing the movable contact to engage the non-movable fixed contact until the reset member is returned toward the position of rest.

13. The method of claim 12, wherein the force causes the contact support member to pivot about a pivot point.

14. A method of resetting a high temperature limit switch, the method comprising the steps of:
moving a reset member from a position of rest toward a reset position to exert force on a contact support member, the contact support member including a fixed end and a first contact remote from the fixed end; and
pivoting the contact support member at a fixed pivot point disposed between the fixed end and the first contact in response to the moving step to prevent the first contact from engaging a second contact while a resettable temperature responsive mechanism is urged from a tripped position to a non-tripped position.

15. A high temperature limit switch comprising;
a resettable temperature responsive mechanism movable between a non-tripped position and a tripped position;
a reset member movable between a position of rest and a reset position;
a pivotable contact support member including a fixed end and a first contact remote from the fixed end;
a fixed contact configured to receive the first contact;
a pivot point disposed between the fixed end and the first contact; and
a moveable actuator disposed between the pivot point and the first contact to urge the resettable temperature responsive mechanism from the tripped position to the non-tripped position in response to movement of the reset member in the direction of the reset position, the first contact being prevented from contacting the fixed contact by force applied at the pivot point until the reset member is returned toward the position of rest.
